(19) United States
(12) Patent Application Publication
(10) Pub. No.: US 2006/0181552 A1
(43) Pub. Date: Aug. 17, 2006

(54) Image display calibration for ultrasound and other systems

(75) Inventor: Jerry D. Hopple, Woodinville, WA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/056,724

(22) Filed: Feb. 11, 2005

(51) Int. Cl. G09G 5/10

(52) U.S. Cl. 345/690

(57) ABSTRACT

A light sensor is positioned to detect and correct for variations in light output by a flat panel display over time. The calibration occurs automatically, rather than in response to user activation of a calibration routine. The light sensor is positioned fixedly and senses in front of the flat panel display. The light sensor is used on a medical diagnostic or other imaging system.

### BACKGROUND

The present invention relates to calibration of an imaging display, such as a medical image display. In particular, a display is altered to maintain a characteristic, such as color, over time.

Many imaging systems, such as personal computers or medical diagnostic ultrasound systems, use CRT displays. CRTs and associated electronics may be manufactured with sufficient stability over the lifetime of the CRT. As a result, calibration may be performed only initially. For medical diagnostic imaging and other display purposes, images generated at different times, such as images separated by years, may desirably have a similar look. For example, in medical diagnostic ultrasound, color coding or grayscale brightness for a two or three dimensional image indicates different types of information, such as different types of tissue or different speeds of movement of tissue or fluids. Since the CRT has long term stability, the same brightness or colors in images generated at different times may have similar meaning.

For increased stability, a suction cup sensor for replaceable positioning on a front of a CRT display has been used. The sensor detects light output by the CRT for calibration in response to manual activation of the calibration program.

Flat panel displays, such as liquid crystal diode (LCD) displays, reduce the amount of space dedicated to display generation. However, flat panel displays may age, such as by altering the color and/or brightness characteristic as a function of time. Images generated at different times may result in different looks, such as a slightly different color or brightness. For medical diagnostic ultrasound imaging or other purposes, the difference in look between different images generated at different times may have to be considered for diagnostic purposes.

LCDs may be calibrated. For example, the backlight of an LCD is stabilized. A sensor is formed within the LCD to sense one or more characteristics of the backlight. The operation of the backlight is altered in response to the sensed characteristic. As the backlight ages, the aging may be compensated. However, altering backlight operation may not correct for aging effects within the liquid crystal display itself or from the viewpoint of the user. The LCD or front of the display may be calibrated by building a sensor within the layers of the liquid crystal display. However, customization of the LCD panel itself may be expensive, such as requiring custom versions of a product which may otherwise be a high volume commodity. Integrated sensing may result in sensor redesign every time a new panel design is created.

### BRIEF SUMMARY

By way of introduction, the preferred embodiments described below include image display calibration for ultrasound and other systems. A light sensor is positioned to detect and correct for variations in light output by a flat panel display over time. The calibration occurs automatically, rather than in response to user activation of a calibration routine, in some embodiments. In other embodiments, the sensor is positioned fixedly and senses in front of the flat panel display. In yet other embodiments, the light sensor is used on an ultrasound or other medical diagnostic imaging system. Other embodiments include combinations of the embodiments discussed above.

In a first aspect, an ultrasound system is provided for calibration of an ultrasound imaging display. A flat panel display has a front side for viewing ultrasound images. A cover and the flat panel display are positionable in an open position for use and in a closed position where the front side is adjacent to the cover. A light sensor is positioned in or on the cover. A processor is operable to calibrate a characteristic of the flat panel display as a function of a signal from the light sensor. The ultrasound images displayed on the flat panel are more likely to have a similar display characteristic over time in response to the calibration.

In a second aspect, a system is provided for calibration of an imaging display. A light sensor is provided separate from a flat panel display. A processor is operable to calibrate a characteristic of the flat panel display as a function of a signal from the light sensor. The processor is operable to calibrate automatically free of user initiation of a calibration routine.

In a third aspect, a method is provided for calibrating an imaging display. A light sensor is provided fixed in or on a cover. Positioning of the light sensor adjacent to a front of a flat panel display is allowed. Color, brightness, or combinations thereof are sensed on the flat panel display with the light sensor. The flat panel display is calibrated as a function of the sensed color, brightness, or combinations thereof.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a graphical representation of one embodiment of a system for calibration of an imaging display in an open position;

FIG. 2 is a graphical representation of the system of FIG. 1 in a closed position; and

FIG. 3 is a flowchart of one embodiment of a method for calibrating an imaging display.

### DETAILED DESCRIPTION OF THE DRAWINGS AND PRESENTLY PREFERRED EMBODIMENTS

In order to provide more accurate grayscale or color images over the lifetime of a flat panel display, a flat panel display is calibrated to a reference level of brightness and/or color purity. The light sensor is located such that the light passing through the flat panel display is detected. The light meant to be seen by the user may be used for calibration. A processor receives the sensed values, compares the values to set points or thresholds and, if needed, controls one or more parameters of the flat panel display to alter the sensed characteristic. The alteration may allow for more accurate brightness or color purity over the lifetime of the flat panel display (e.g., aging), in response to environmental changes (e.g. temperature), process variations (e.g., calibrating different displays to a same standard) or for other reasons. By using a light sensor separate from the flat panel display, such as not integrated within a liquid crystal display, customization of the display may be minimized.

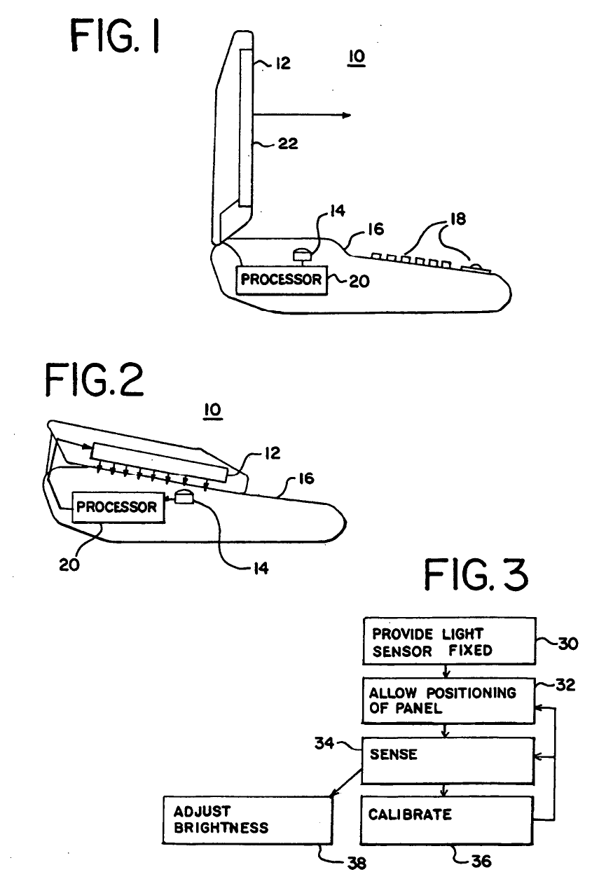

FIGS. 1 and 2 show one embodiment of a system 10 for calibration of an imaging display. The system 10 is a personal computer, laptop, workstation, medical diagnostic imaging system, or other now known or later developed system for displaying images. For example, the system 10 is a workstation or computer for displaying satellite or telescope images. As another example, the system 10 is a medical diagnostic ultrasound imaging system that is cart mounted, portable, handheld or permanently positioned. While shown as similar to a laptop computer, the system 10 may include additional components, such as the system 10 shown in FIGS. 1 and 2 being connected with or formed as part of a larger housing for additional components. As a medical diagnostic ultrasound system, the system 10 is formed with or connects with a housing including transmit and receive beamformers, image processing circuitry, a scan converter, a detector (e.g., detector for detecting grayscale B-mode images or color scale Doppler mode images), or other components. An ultrasound transducer may connect with the system 10 or other components connected with the system 10.

The system 10 includes a flat panel display 12, a light sensor 14, a cover 16, user input devices 18 and a processor 20. Additional, different or fewer components may be provided, such as additionally providing ultrasound circuitry. As another example, the flat panel display 12, light sensor 14 and processor 20 are provided without the user input devices 18 and/or without the separate cover 16.

The flat panel display 12 is a liquid crystal display, a plasma screen display, a diode based display or other now known or later developed flat panel display device. The flat panel display 12 is of any of various sizes, such as 15 to 50 inches along a diagonal across the front 22 of the flat panel display 12. The depth may be from millimeters to inches, such as being two or fewer inches without a housing. As a liquid crystal display, the flat panel display 12 includes a backlight and a liquid crystal screen. The flat panel display 12 is operable to generate black and white or grayscale images and/or RGB, YUV or other color scale images.

The front 22 of the flat panel display 12 is operable to be closed or positioned adjacent to the cover 16, such as shown in FIG. 2. In an open position shown in FIG. 1, the front 22 of the flat panel display 12 is oriented for viewing by a user. In the closed position shown in FIG. 2, the front 22 of the flat panel display 12 is positioned adjacent to the cover 16 and associated light sensor 14. A hinge, armature or other device allows for relative positioning of the flat panel display 12 adjacent to the cover 16. While FIG. 2 shows immediately adjacent positioning of the flat panel display 12 to the cover 16, a gap or space may be provided in other embodiments. In yet other embodiments, the flat panel display 12 is fixed and the cover 16 rotates to, connects with, or slides onto the flat panel display 12. In alternative embodiments, the cover 16 is positioned adjacent to the flat panel display 12 in a fixed arrangement, such as associated with the base of the flat panel 12 shown in FIG. 1 being adjacent to a left most portion of the cover 16. In yet other alternative embodiments, the cover 16 is not provided.

The cover 16 is plastic, fiberglass, wood, metal, resin, combinations thereof or other now known or later developed material for covering or housing. The cover 16 is a cover for the flat panel display 12 and/or a cover for other components, such as the processor 20 and/or the user input devices 18. The cover 16 is shaped or formed as needed, such as providing a flat surface for mating with the flat panel display 12 or a molded surface for housing various components. In one embodiment, the cover 16 is a housing of a control panel for the user input devices 18. For example, the cover 16 is a housing for a keyboard, trackball, touch sensor, sliders, dials, buttons, capacitance sensors, combinations thereof or other now known or later developed user input devices. For use on a medical diagnostic ultrasound imaging system, a control panel may include a keyboard, sliders, a trackball or mousepad and/or other input devices. One or more of the user input devices 18 may be specific for the type of device, such as a B-mode, flow mode or other ultrasound specific control.

The light sensor 14 is a silicone detector, a charge coupled device, a CMOS detector, a photodiode (e.g. organic light emitting diode), or other now known or later developed light sensitive devices. In one embodiment, the light sensor 14 is a color sensor of photodiodes, color filters and transimpedance amplifiers for detecting one, two, three or more different color characteristics, such as RGB or YUV color output. The same or different components may be used for detecting brightness, luminance or other display characteristics. For example, a plurality of photodiodes are provided with associated filters for detecting red, green, blue and wideband light. Any bandwidth for each associated color characteristics or the overall intensity may be provided. Voltage, current, frequency or other output signal variation is used to indicate a detected characteristic.

While shown as one sensor 14, the light sensor 14 may include a plurality of different types or the same types of sensors in a fully or a sparsely populated array. Optics, such as one or more lenses may be positioned adjacent to or within the sensor 14 for focusing an area to be sensed. For example, a series of lenses are provided for focusing the light sensor 14 at a focal position spaced away from the light sensor 14, such as on the front 22 of the flat panel display 12 while in the open position shown in FIG. 1, the closed position shown in FIG. 2 or a different position. Alternatively, no lenses or filters are provided.

The light sensor 14 is separate from the flat panel display 12. The light sensor 14 is a different component or is not integrated on a same substrate or structure with the flat panel display 12, such as being separate from the liquid crystal layer or backlight. To more accurately calibrate the flat panel display 12 from a user's perspective, the light sensor 14 is positionable adjacent to the front 22 of the flat panel display 12. The light sensor 14 may be positionable at other locations, such as using a suction cup, clip, latch or other mating structure for manually or releasably repositioning the light sensor 14. Alternatively, the light sensor 14 is fixed within or on a housing. As used herein, fixed indicates a mounting not intended for release during normal operation, such as providing a sensor underneath a cover 16 with a lens or aperture for allowing operation. Screws, latches or other structures may be used to remove the cover and/or light sensor 14 maintenance of the fixed light sensor 14. For example, the light sensor 14 connects to a housing of the flat panel display 12, such as extending on an arm or other structure to the side and in front of the flat panel display 12. In the embodiment shown in FIGS. 1 and 2, the light sensor 14 is fixedly positioned in or on the cover 16. The cover 16 is a housing separate from the flat panel display 12. The housing surrounding the flat panel display is likewise a separate housing.

In the embodiment shown in FIG. 2, the light sensor 14 is positioned within the cover 16 such that the light sensor 14 is adjacent to a portion of the front 22 of the flat panel display 12 when the flat panel display 12 is in a closed position. The front 12 is positioned adjacent to the control panel of the cover 16 in the light sensor 14. The light sensor 14 senses a single pixel, a group of pixels, a plurality of different groups of pixels, the entire flat panel display 12 or other regions of the imaged area. In an alternative embodiment, the light sensor 14 is operable to sense displayed light from the front 22 of the flat panel display 12 from a distance greater than associated with closing the flat panel display 12 adjacent to the cover 16. For example, the light sensor 14 shown in FIG. 1 may be operable to focus on a single pixel, region of pixels, multiple regions of pixels or the entire front 22 of the flat panel display 12 while in the open position. Light sensors 14 positioned in other locations on or within the cover 16 or spaced away from the cover 16 may similarly sense light from the flat panel display 12. For example, four, six or other number of light sensors 14 are positioned to sense light from one or more pixel locations within a respective number of regions of the flat panel display 12.

The processor 20 is a general processor, digital signal processor, application-specific integrated circuit, field programmable gate array, digital circuit, analog circuit, control processor, combinations thereof, or other now known or later developed device for sampling signals from the light sensor 14 and controlling the flat panel display 12. The processor 20 is a single processor or plurality of processors, such as a processor associated with the light sensor 14 connected with a different processor associated with the flat panel display 12. The processor 20 is dedicated to calibration or also performs other functions, such as control functions of a medical diagnostic ultrasound imaging system or data processing functions for imaging.

The processor 20 is operable to calibrate one or more characteristics of the flat panel display 12 as a function of signals from the light sensor 14. The detected color, luminance, brightness or other characteristic is output by the light sensor 14 or sampled by the processor 20. For example, the processor 20 receives signals indicating at least three color characteristics and a luminance or brightness. The color values, such as RGB values, and luminance levels are used to determine the condition of the flat panel 12. The values are compared to thresholds or previous values. If the difference in one or more characteristics exceeds a threshold amount from the expected or desired values, the processor 20 is operable to control the flat panel display 12 or other image processing to more likely result in output with the desired characteristics.

In one embodiment, the processor 20 causes a specific image sequence to be displayed on the flat panel display 12. For example, a series of different colors are output at a region, pixel or multiple regions sensed by the light sensor 14. The detected characteristics may then be compared to expected characteristics based on the expected output. A sequence of outputs is provided, or a single image may be used for generating or sensing a plurality of different characteristics.

In response to the comparison, the processor 20 may alter a characteristic of the flat panel display 12. For example, the processor 20 controls brightness, contrast, gamma or combinations thereof of the plat panel display 12. By identifying an amount of deviation of a single characteristic or a plurality of different characteristics, a single or combination of adjustments of the flat panel display 12 are implemented by the processor 20. Alternatively or additionally, the processor 20 causes alteration or selection of a different color look-up table. For medical or other imaging, the color to be displayed is selected from a look-up table as a function of the input values. By providing different look-up tables based on the difference in characteristic or output light by the flat panel display 12, the different look-up tables may be selected for use at different times so that the resulting image output by the flat panel display 12 has a similar color scheme despite aging. By altering the output of the flat panel display 12 through calibration, ultrasound or other images displayed on the flat panel display 12 are more likely to have similar display characteristics over time despite the aging. Calibration provides consistency for medical diagnostic or other imaging.

The calibration is performed automatically, free of user initiation of a calibration routine. For example, the processor 20 automatically performs the calibration in response to user actions other than initiation of the calibration routine. When the flat panel display 12 is positioned in a closed position or adjacent to the cover 16 as shown in FIG. 2, the calibration routine may be triggered. Other triggers for performing calibration may include turning on or off the system 10. Periodic calibration may be provided. The processor 20 activates calibration based on a clock, such as after a number of hours, days, weeks or months. Less or more frequent calibration may be provided. The clock may be based on the actual time or time of operation or usage. For example, calibration is performed when the system 10 is shut down or turned off if not performed within the last week or other time period. Where temperatures tend to fluctuate regularly or other environmental changes that may affect the light output from the flat panel display 12 occur more frequently, calibration may be performed more frequently. In alternative embodiments, the user initiates the calibration routine, such as by selecting activation of a calibration routine using the user input 18.

The calibration may be performed without any further activity by the user. Alternatively, the user is prompted by a displayed message, an audible beep or other mechanism to position the flat panel display 12 in a closed position or otherwise prepare for color calibration. Similar visual or audio mechanism may be used to communicate that the calibration is complete.

The settings for the flat panel display 12 and/or color look-up table are saved for continuous use during operation of the system 10 until a subsequent calibration. Using register settings within the flat panel display 12 or other color look-up table selection, more consistent imaging may be provided. The settings may be re-measured and reiterated during a single calibration to maximize the calibration.

The light sensor 14 and processor 20 may be used for additional or different purposes. For example, the light sensor 14 is operable to sense ambient light. The brightness level of the flat panel display 12 may be altered as a function of the ambient light sensed by the light sensor 14. Other characteristics than brightness may be altered. For color consistency, the color characteristics of the ambient light may be sensed for altering color characteristics of the flat panel display 12. Ambient light detection may be used to adjust other lights as well, such as keyboard backlights or room lighting. Wired or wireless communication is provided between the light sensor 14 and any component of the processor 20, such as using wireless communications to a processor 20 remotely located for operating room lighting.

FIG. 3 shows one embodiment of a method for calibrating an imaging display. The method is implemented using the system 10 shown in FIG. 1 or 2, or a different system. Additional, different or fewer acts may be provided, such as providing acts 30 and 34 without act 38, 30 and/or 32. The acts may be performed in the order shown or a different order.

In act 30, a light sensor is provided in or on a cover or elsewhere. For example, a light sensor is mounted in or on a control panel. The light sensor is fixedly mounted, but may alternatively be releasably mounted.

In act 32, the light sensor is allowed to be positioned adjacent to the front of the flat panel display. For example, the light sensor is fixedly positioned adjacent to the flat panel display without requiring any additional motion or alteration. As another example, rotation or other movement of a control panel or other cover relative to the front of the flat panel display is allowed. The movement positions the front of the flat panel display adjacent to the light sensor, such as adjacent to a control panel housing the light sensor. Alternatively, the light sensor is maintained spaced away from the flat panel display for remote sensing.

In act 34, color, brightness, combinations thereof or other characteristic of the flat panel display are sensed with the light sensor. By sensing a color characteristic, the color output in the light of the flat panel display may be calibrated. The same or different light sensor positioned in a same or different location or substrate is used to sense the same or different characteristics of the light output by the flat panel display. Alternatively or additionally, the same or different sensor is used for sensing ambient light.

In act 36, the flat panel display is calibrated. The calibration is performed as a function of the sensed color, brightness, other characteristics or combinations thereof. The sensed characteristic is compared to expected or desired values. An amount of difference is then used to determine an adjustment for altering the output of the flat panel display. For example, the brightness, contrast, gamma or other control of the flat panel display is altered. As another example, a color or gray scale look-up table for use in generating images is altered or selected as a function of the sensed color characteristic, brightness or other characteristic.

The calibration and associated sensing of acts 34 and 36 are triggered. The triggering is performed in response to software, firmware or hardware, such as in response to a timer associated with time of use or actual time. Other triggers may be provided, such as triggering in response to the positioning allowed in act 32. The sensing in calibration acts 34 and 36 are triggered when the cover is adjacent to the front of the flat panel display. The sensing and calibration acts 34 and 36 are repeated over time so that the color, brightness or combinations thereof are substantially maintained. The same or different events may be used to trigger the sensing and calibration at different times. In alternate embodiments, the user activates a calibration routine with the user inputs.

Images, such as ultrasound or other medical images may be displayed at different times, such as separated by days, hours, weeks, months or years. Where calibration is performed in between the generation of the display of different images, aging of the flat panel display may be counteracted. As a result, the images may have a substantial consistency in color, brightness or combinations thereof. As the flat panel display ages or is subjected to different environmental conditions, the output color, brightness or other light characteristic of the flat panel display may be similar between different images. Similarity may allow for more consistent diagnosis or user appeal.

In act 38, the brightness or other characteristic of the flat panel display is altered as a function of sensed light. For example, the flat panel display brightness is altered as a function of sensed ambient light. Where a greater amount of ambient light is provided, a greater brightness or luminance setting is used for the flat panel display. For more dimly lit work areas, a reduced brightness may avoid eye strain.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. An ultrasound system for calibration of an ultrasound imaging display, the system comprising:
a flat panel display having a front side for viewing ultrasound images;
a cover, the cover and flat panel display positionable in an open position for use and a closed position wherein the front side is adjacent the cover;
a light sensor positioned in or on the cover; and
a processor operable to calibrate a characteristic of the flat panel display as a function of a signal from the light sensor;
whereby ultrasound images displayed on the flat panel display are more likely to have a similar display characteristic over time in response to the calibration.

2. The ultrasound system of claim 1 wherein the cover comprises a control panel having a plurality of user input devices, the light sensor being positioned on the control panel such that the light sensor is adjacent to a portion of the front side of the flat panel display in the closed position.

3. The ultrasound system of claim 1 wherein the characteristic comprises at least two color characteristics and wherein the light sensor is operable to detect the at least two color characteristics.

4. The ultrasound system of claim 1 wherein the characteristic comprises three color characteristics and luminance and wherein the light sensor is operable to detect the three color characteristics and luminance.

5. The ultrasound system of claim 1 wherein the flat panel display comprises a liquid crystal display.

6. The ultrasound system of claim 1 wherein the processor is operable to alter the characteristic of the flat panel display as a function of brightness, contrast, gamma, color look-up table or combinations thereof.

7. The ultrasound system of claim 1 wherein the processor is further operable to alter brightness of the flat panel display as a function of ambient light sensed by the light sensor.

8. The ultrasound system of claim 1 wherein the processor is operable to perform the calibration when the cover and flat panel display are in the closed position.

9. The ultrasound system of claim 1 wherein the processor is operable to calibrate automatically free of user initiation of a calibration routine.

10. A system for calibration of an imaging display, the system comprising:
a flat panel display;
a light sensor separate from the flat panel display; and
a processor operable to calibrate a characteristic of the flat panel display as a function of a signal from the light sensor, the processor operable to calibrate automatically free of user initiation of a calibration routine.

11. The system of claim 10 wherein the processor is operable to automatically calibrate in response to user actions other than initiation of the calibration routine.

12. The system of claim 10 wherein the light sensor is positionable adjacent to a front of the flat panel display, the flat panel display operable to be viewed from the front.

13. The system of claim 10 further comprising a control panel having a plurality of user input devices, wherein a front side of the flat panel display is operable to be positioned adjacent to the control panel, the light sensor being positioned on the control panel such that the light sensor is adjacent to a portion of the front side of the flat panel display when the front side is positioned adjacent to the control panel.

14. The system of claim 13 wherein the processor is operable to perform the calibration when the front side is positioned adjacent to the control panel.

15. The system of claim 10 wherein the characteristic comprises three color characteristics and luminance and wherein the light sensor is operable to detect the three color characteristics and luminance.

16. The system of claim 10 wherein the flat panel display comprises a liquid crystal display.

17. The system of claim 10 wherein the processor is operable to alter the characteristic of the flat panel display as a function of brightness, contrast, gamma, color look-up table or combinations thereof.

18. The system of claim 10 wherein the processor is further operable to alter brightness of the flat panel display as a function of ambient light sensed by the light sensor.

19. The system of claim 10 wherein the light sensor is fixed within a housing separate from the flat panel display.

20. A method for calibrating an imaging display, the method comprising:
providing a light sensor fixed in or on a cover;
allowing positioning of the light sensor adjacent to a front of a flat panel display;
sensing color, brightness or combinations thereof of the flat panel display with the light sensor; and
calibrating the flat panel display as a function of the sensed color, brightness or combinations thereof.

21. The method of claim 20 wherein sensing comprises sensing a color characteristic and calibrating comprises calibrating as a function of the color characteristic.

22. The method of claim 20 wherein providing the light sensor comprises mounting the light sensor in or on a control panel and wherein allowing positioning of the light sensor comprises allowing rotation of the control panel relative to the front of the flat panel display such that the front is adjacent to the control panel.

23. The method of claim 20 further comprising:
repeating the sensing and calibrating steps over time such that the color, brightness or combinations thereof are substantially maintained.

24. The method of claim 23 further comprising:
displaying first and second ultrasound images a different times with the calibrating having been performed between the different times, the calibrating operable to adjust for aging of the flat panel display such that the first and second ultrasound images have substantial consistency in color, brightness or combinations thereof.

25. The method of claim 20 further comprising:
triggering the sensing and calibration when the cover is adjacent to the front of the flat panel display.

26. The method of claim 20 wherein calibrating comprises altering the flat panel display as a function of brightness, contrast, gamma, color look-up table or combinations thereof.

27. The method of claim 20 further comprising:
sensing ambient light with the light sensor; and
altering a brightness of the flat panel display as a function of the ambient light.
